(19) United States
(12) Patent Application Publication
(10) Pub. No.: US 2004/0010756 A1
(43) Pub. Date: Jan. 15, 2004

(54) Print preview based on printer attributes and/or material properties of print media

(76) Inventor: George Bradley Hobbs, Caldwell, ID (US)

Correspondence Address: HEWLETT-PACKARD COMPANY, Intellectual Property Administration, P.O. Box 272400, Fort Collins, CO, 80527-2400, US

(21) Appl. No.: 10/191,610

(22) Filed: Jul. 9, 2002

(51) Int. Cl. G06F 15/00

(52) U.S. Cl. 715/526

(57) ABSTRACT

Various systems, methods, and computer programs embodied in a computer readable medium to generate a print preview are provided. In one embodiment, a method includes the steps of providing a digital document for printing and specifying a printer upon which the digital document is to be printed. The visual appearance of the digital document as printed by the printer is affected by a printer attribute of the printer. Therefor, the method also includes the step of rendering the print preview of the digital document on a display device where the print preview simulates the visual appearance of the digital document as affected by the printer attribute of the printer.

### BACKGROUND

Networks now allow computers to communicate with printers at significant distances. Such printers may include a number of different types of print media upon which documents generated by the computers can be printed. For example, an individual may generate a document using a computer that is coupled to the Internet. The same user may wish to print out multiple copies of the document using a printer that is coupled to the Internet as well, but is located at a print shop. In some situations, the distance between the individual and the print shop is too far to allow the user to visit the print shop to see what the document will look like when printed on a particular print media. This can be problematic given that the print media and the printer technology may affect the appearance of the document when printed.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of an exemplary data communications network that includes a client upon which a print preview is depicted according to an embodiment of the present invention;

FIG. 2 is a block diagram that provides an example of the client of FIG. 1 according to an embodiment of the present invention;

FIGS. 3A and 3B are drawings of an exemplary media material property table and a printer attribute table, respectively, employed according to an embodiment of the present invention in generating the print preview of FIG. 1;

FIG. 4 is a drawing of an exemplary graphical user interface that is generated according to an embodiment of the present invention on a display device of the client of FIG. 2 to present the print preview of FIG. 1 to a user;

FIG. 5 is a flow chart of an exemplary media compensator according to an embodiment of the present invention executed in the client of FIG. 1 to generate the print preview of FIG. 4; and

FIG. 6 is a flow chart that further illustrates an example of a rendering function according to an embodiment of the present invention that may be executed as part of the media compensator of FIG. 5.

### DETAILED DESCRIPTION

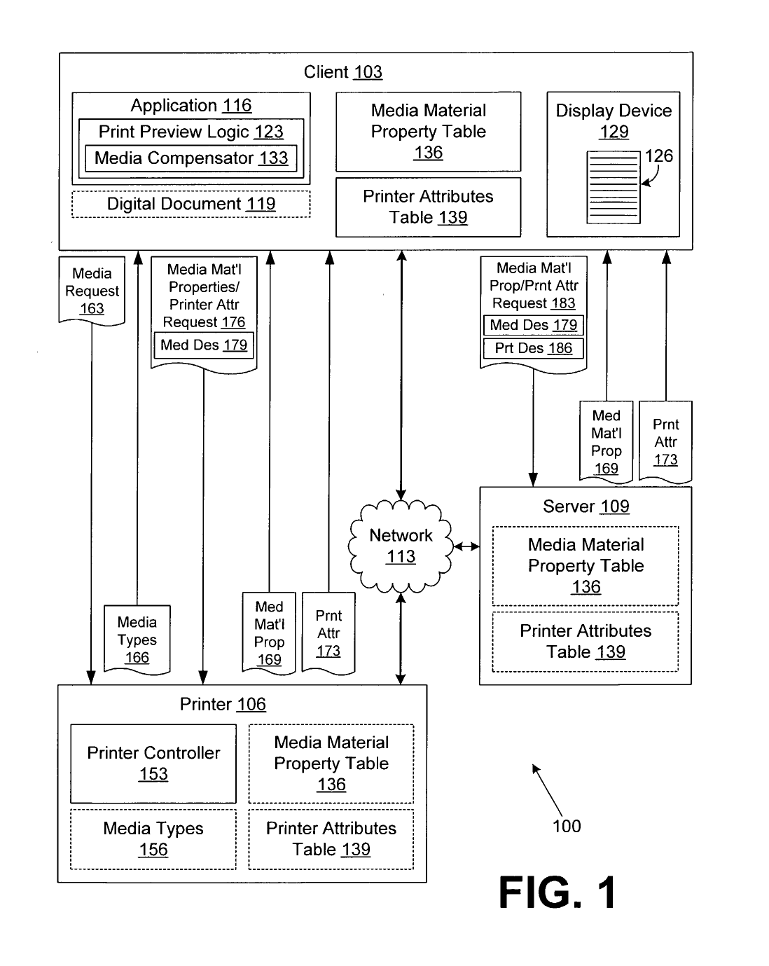

With reference to FIG. 1, shown is an exemplary data communications network 100 that includes a client 103, a printer 106, and a server 109, all of which are coupled to a network 113. In this respect, the network 113 may be, for example, the Internet, intranets, wide area networks (WANs), local area networks, wireless networks, or other suitable networks, etc., or any combination of two or more such networks.

The client 103 may be, for example, a computer system or other apparatus with similar capability. The client 103 includes one or more exemplary applications 116 that may be employed to generate one or more digital documents 119. The application 116 includes print preview logic 123 that may be employed to generate a print preview 126 of the digital document on a display device 129 that is associated with the client 103. The print preview logic 123 includes a media compensator 133 that is employed in rendering the print preview 126 of the digital document 119. The client 103 may also include a media material property table 136 and a printer attributes table 139. In generating the print preview 126, the media compensator 133 may consult the media material property table 136 and the printer attributes table 139 as will be discussed.

The printer 106 may be, for example, a laser printer, an ink jet printer, a dot matrix printer, a digital offset press, or other type of printer. The printer 106 includes the printer controller 153 that controls the general operation of printer 106 as is generally understood by those with ordinary skill in the art and not discussed in detail herein. In addition, the printer 106 may include a number of different types of print media, hereafter referred to as “media types” 156, that the printer may employ in printing various documents. Each of the media types 156 may be maintained in a table or other construct in the printer 106. In addition, a printer attributes table 139a and the media material property table 136 may also be maintained in the printer 106.

In this respect, the printer 106 may include a processor circuit having a processor and a memory. The printer controller 153 is stored in the memory and is executable by the processor as can be appreciated by those with ordinary skill in the art. In addition, the media types 156, printer attributes table 139a and the media material property table 136 can be stored in the memory in the printer 106. The printer attributes table 139a includes printer attributes that are associated with the printer 106 itself. As such, it may differ from the printer attributes table 139 stored in the client 103 above in that the printer attributes table 139 may include printer attributes from a number of different printers as will be discussed.

As an alternative, the media material property table 136 and the printer attributes table 139 may be stored on the server 109 and made available to the client 103 or the printer 106 through the network 113.

Next, the operation of the various components of the data communication network 100 are described with reference to generating the print preview 126 of the digital document 119 on the display device 129. To begin, assume that a user of client 103 manipulates an application 116 to generate a digital document 119 that they wish to print. Also, the user selects the printer 106 for printing the digital document 119 by manipulating an appropriate user interface, etc. Although it is assumed that the printer 106 is selected for printing, any printer coupled to the network 113 may be selected for printing as can be appreciated by one of ordinary skill in the art.

In addition, assume, for example, that the printer 106 is located separate from the client 103 such that the user would not have direct access to the printer 106 to view the digital document 119 as printed thereon. In addition to wanting to print the digital document 119 on the printer 106, assume, for example, that the user wishes to print the document 119 using a specific print media that is available to the printer 106. Thus, in this scenario, the printer 106 may provide multiple types of print media upon which the digital document 119 may be printed. Such print media may include, for example, standard paper, bond paper, cotton based paper, transparencies, or other types of print media. The print media may be constructed either wholly or partially of various materials, for example, of wood (paper), plastic, fabric, cotton, metal, or any other materials, or a combination of any two or more of the above materials.

Each type of the print media that is provided by the printer 106 may affect the appearance of the digital document 119 when printer thereon. In addition, the printing technology within the printer 106 that is employed to accomplish a printer operation may also affect the ultimate appearance of the digital document 119 as printed in the printer 106. As such, a user may interface with the printer 106 to select a print media for printing the digital document 119. However, the ultimate document as printed may not look precisely how the user would like it to look due to the variation imposed by the nature of the print media and the printing technology employed in the printer 106. Specifically, the printer attributes listed in the printer table 139a, and the material properties of the various print media available in the printer 106 and listed in the media material property table 136 may impose a variation in the visual appearance of the digital document 119 as printed by the printer 106 on a respective print media.

According to an embodiment of the present invention, the client 103 provides for the generation of the print preview 126 of the digital document 119 that takes into account the printer attributes of the printer 106 and the material properties of the selected print media. By taking these factors into account when generating the print preview 126, a user may be apprised of the precise visual appearance of the digital document 119 when printed by the printer 106 on the desired print media. In this respect, the user may manipulate the print preview logic 123 to generate the print preview 126 of the digital document 119 on the display device 129. The print preview logic 123 includes the media compensator 133 that ensures that the rendering of the print preview 126 of the digital document 119 is an accurate depiction of the digital document 119 as it would appear when printed by the printer 106 on the desired print media.

Once executed, the media compensator 133 generates a media request 163 for a list of media types 166 from the printer 106. The printer controller 153 may include logic to respond to the media request 163 by compiling the list of media types 166 and transmitting them back to the client 103. Alternatively, the list of media types 166 may simply be located in a memory in the printer 106 that is accessible to the client 103 through the network 113. Assuming the former, then printer 106 transmits the media types 166 back to the client 103 in response to the media request 163. Thereafter, the media compensator 133 provides for a selection of a desired media type 166 by a user of the client 103 through, for example, a graphical user interface displayed on the display device 129. Such may be accomplished, for example, with a pick list, drop down list or other graphical user device. In addition, other user interfaces may be provided to facilitate such selection as can be appreciated by those with ordinary skill in the art.

Once the media types 166 are known, then the client 103 obtains the media material properties 169 associated with a selected one of the media types 166 and the printer attributes 173 associated with the destination printer 106. This is done in order to be able to generate the print preview 126 that simulates the appearance of the digital document 119 as it would be printed on the selected print media by the printer 106. In one approach, the client 103 generates a media material property/printer attribute request 176 that is transmitted to the printer 103. The media material property/printer attribute request 176 includes a media designator 179 that specifies the specific one of the media types 166 that is selected for printing the digital document 119 on the printer 106. In response, the printer controller 153 responds by sending the media material properties 169 and the printer attributes 173 that are obtained from the media material property table 136 and the printer attributes table 139a, respectively, to the client 103.

Alternatively, in a second approach the same media material properties 169 and the printer attributes 173 may be obtained from the media material property table 136 and the printer attributes table 139, respectively, that are stored in the client 103. This assumes, of course, that the media material property table 136 and the printer attributes table 139 are both stored in the client 103 which may not always be the case.

In a third approach, a media material property/printer attribute request 183 may be generated and transmitted to the server 109 for the media material properties 169 and the printer attributes 173. The media material property/printer attributes request 183 includes the media designator 179 and a printer designator 186. Both are included so that the media material properties 169 of the selected print media and the printer attributes 173 associated with the ultimate destination printer 106 may be obtained from the media material property table 136 and the printer attributes table 139, respectively. The server 109 responds to the media material property/printer attributes request 183 by transmitting the respective media material properties 169 and printer attributes 173 to the client 103.

Once the media material properties 169 of the selected print media and the printer attributes 173 associated with the destination printer 106 are known, then the media compensator 133 proceeds to render the digital document 119 on the display device 129 as the print preview 126. In rendering the digital document 119 as the print preview 126, the media compensator 133 incorporates any effects that the media material properties 169 and printer attributes 173 have upon the visual appearance of the digital document 119. Thus, the print preview 126 provides a depiction of the digital document 119 with a visual appearance that simulates the appearance of the digital document 199 as it is printed by the printer 106 on the selected print media. In this manner, the user is provided with an accurate depiction of the digital document 119 in the print preview 126.

Thus, the media compensator 133 takes into account the attributes of the printer 106 and the media material property 169 of the print media in rendering the digital document 119 as the print preview 126. Assuming that the print preview 126 is acceptable, then the user may direct the application 116 to generate a print job 193 that includes digital document 119 and send the print job 193 to the printer 106 for printing on the respective print media. The print job 193 includes the media designator 179 so that the printer 106 may determine which print media is to be employed for printing the digital document 119.

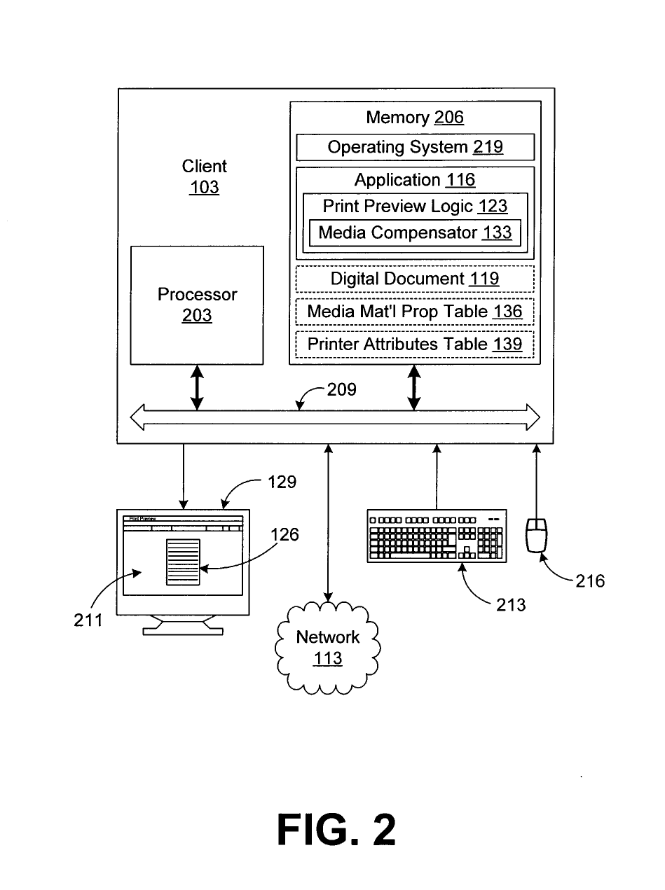

Turning then to FIG. 2 shown is a block diagram of the client 103 according to an embodiment of the present invention. The client 103 may be, for example, a computer system or other apparatus with like capability. In this respect, the client 103 includes a processor 203 and a memory 206, both of which are coupled to the local interface 209. The local interface may be, for example, a control/address bus as can be appreciated by those with ordinary skill in the art. The client 103 is depicted with a keyboard 213 or a mouse 216 that may be employed to input appropriate information into the client 103 and to manipulate various user interfaces displayed on the display device 129. The client 103 may also include other peripheral devices such as a keypad, touch pad, touch screen, microphone, scanner, joystick, or one or more push buttons, etc. The peripheral devices may also include indicator lights, speakers, printers, etc. The display device 129 may be, for example, a cathode ray tube (CRT), liquid crystal display screen, gas plasma-based flat panel display, or other type of display device, etc.

Stored in the memory 206 and executable by the processor 203 are an operating system 219 and the application(s) 116 with the print preview logic 123 and the media compensator 133. Also stored in the memory 206 are one or more digital documents 119 that are created by the application(s) 116, the media material property table 136, and the printer attributes table 139. When executed, the print preview logic 123 and the media compensator 133 generate a graphical user interface 211 that depicts the print preview 126 on the display device 129.

The memory 206 is defined herein as both volatile and nonvolatile memory and data storage components. Volatile components are those that do not retain data values upon loss of power. Nonvolatile components are those that retain data upon a loss of power. Thus, the memory 206 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 203 may represent multiple processors and the memory 206 may represent multiple memories that operate in parallel. In such a case, the local interface 209 may be an appropriate network that facilitates communication between any two of the multiple processors, between any processor and any one of the memories, or between any two of the memories etc. The processor 203 may be electrical, molecular, or optical in nature.

The operating system 216 is executed to control the allocation and usage of hardware resources in the client 103 such as the memory, processing time and peripheral devices. In this manner, the operating system 219 serves as the foundation on which applications depend as is generally known by those with ordinary skill in the art.

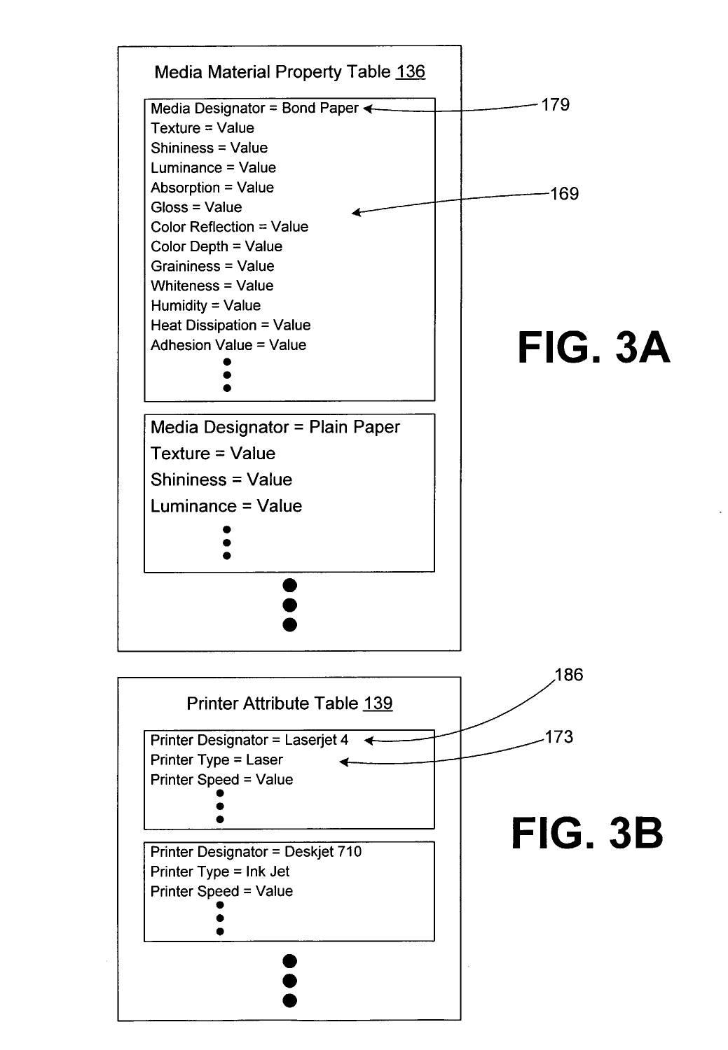

With reference to FIG. 3A, shown is the media material property table 136 according to an embodiment of the present invention. The media material property table 136 lists the media material properties 169 associated with a number of print media types. The media material properties 169 are each associated with a specific media designator 179 for each media in separate lists. Such information may be maintained in, for example, a database, lookup table or other storage format. The media material properties 169 may be, for example, a texture, shininess, absorption, luminance, gloss, cover reflection, color depth, graininess, whiteness, humidity, heat dissipation, adhesion value, thickness or other property of a respective print media. The term “material properties” is defined herein as the properties of a particular material of which a print media is made.

With reference to FIG. 3B, shown is a printer attribute table 139 that lists the printer attributes 173 associated with a number of different printers as designated by the printer designators 186. As such, the printer designators 186 identify the specific model or make of the printer 106. The printer type indicates the technology employed within the printer to perform the printing operation such as, for example, ink, dry toner, off set presses, liquid toner, etc. Other printer attributes may also be listed as well.

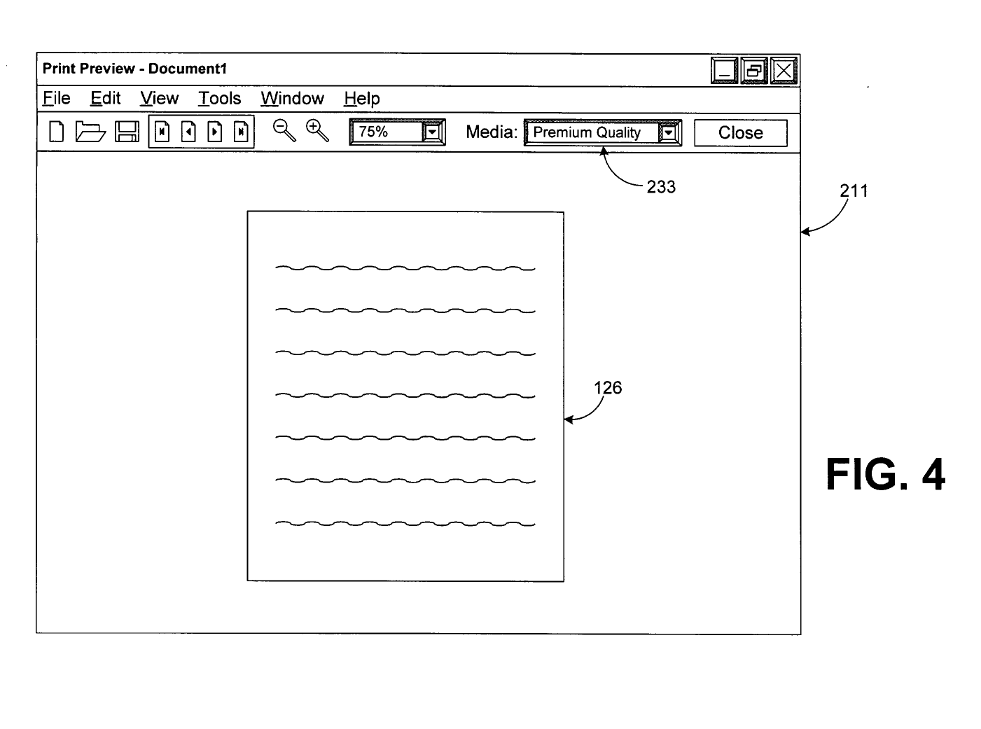

With reference to FIG. 4, shown is an example of the graphical user interface 211 that is depicted on the display device 129 (FIG. 2). The graphical user interface 211 depicts the print preview 126. The graphical user interface 211 also includes a print media selector 233 that a user may manipulate to identify the print media that is to be used to render the print preview 126. The types of print media that may be included in the print media selector 233 are those that may be obtain from the printer 106 in response to the media request 163. Assuming that a user manipulates the print media selector 233 to alter the print media selected, then the media compensator 133 responds by sending a second media material property/printer attribute request 176 to the printer 106 or may obtain such information by virtue of the other approaches as discussed previously. The media compensator 133 then proceeds to render the digital document 119 as the print preview 126 as it would appear as printed on the newly selected print media by the predefined printer 106.

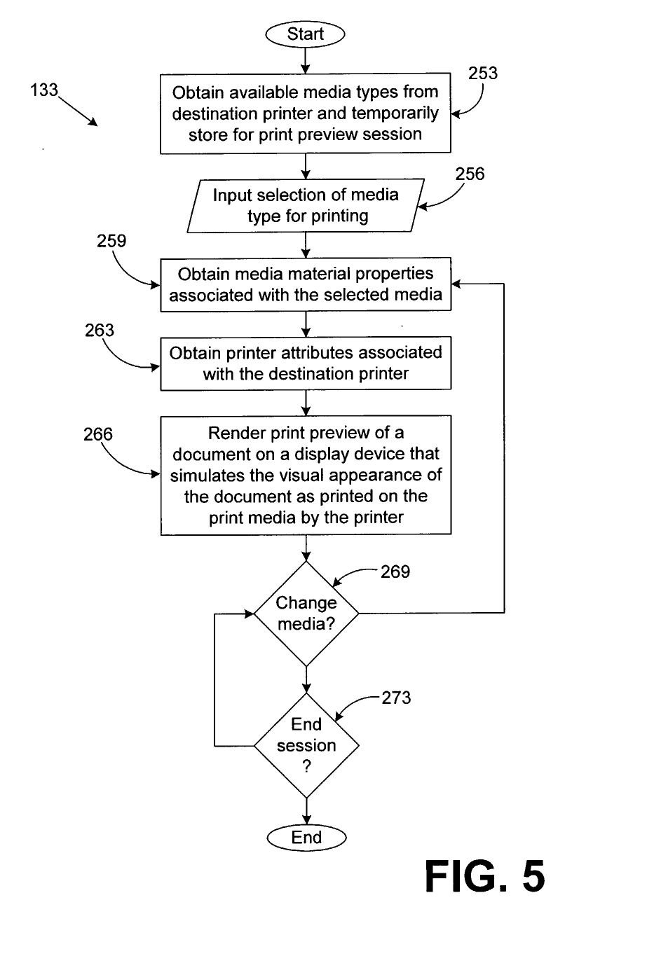

With reference to FIG. 5, shown is a flow chart of an exemplary media compensator 133 according to an embodiment of the present invention. Alternatively, the flow chart of FIG. 5 may be viewed as depicting steps in the method implemented in the client 103. This method would be implemented to generate the print preview 126 on the display device 129 that simulates the visual appearance of the digital document 119 (FIG. 1) as it is affected by the media material properties 169 of the respective print media and by the printer attributes 173 of the printer 106 (FIG. 1). In this respect, the visual appearance of the digital document 119 as printed on the print media is affected by the media material properties 169 of the print media and the printer attributes 173 of the printer 106.

Beginning with box 253, once executed, the media compensator 133 obtains the available media types 166 (FIG. 1) from the destination printer 106 and temporarily stores them, for example, in the memory 206 of the client 103 for use during a print preview session. Thereafter, in box 256 the media compensator 133 inputs a selection from a user of a desired media type upon which the digital document 119 is to be printed. In order to facilitate such a selection, the media compensator 133 may generate an appropriate user interface on the display device 129. Thereafter, once the selection of the respective print media has been made, then in box 259 the media material properties 169 (FIG. 3A) of the selected print media are obtained. Then, in box 263, the printer attributes 173 (FIG. 3B) are obtained.

Next, in box 266, the media compensator 133 renders the print preview 126 of the digital document 119 on the display device 129. The print preview 126 simulates the visual appearance of the digital document 119 as printed on the selected print media 106 taking into account the media material properties 169 and the printer attributes 173. Thereafter, in box 269, the media compensator 133 determines whether a new print media has been selected using the print media selector 233 (FIG. 4). If so, then the media compensator reverts back to box 259 to ultimately render the new version of the print preview 126. Otherwise, the media compensator proceeds to box 273 in which it is determined whether the print preview session has ended.

Such may be the case, for example, if the user manipulates a “Close” button or other component on the graphical user interface 211 (FIG. 4). If such is the case, then the media compensator 133 ends as shown. Otherwise, the media compensator 133 reverts back to box 269. In this manner, the user may generate several different print previews 126 of the digital document 119 that are altered so as to simulate the appearance of digital document 119 as printed on the selected print media as printed by the printer 106.

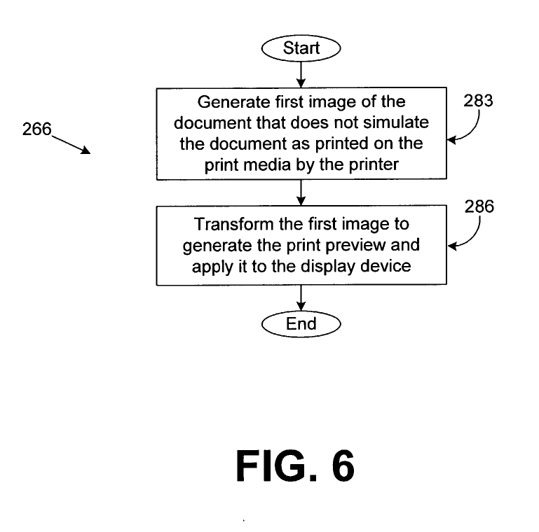

With reference to FIG. 6, shown is an exemplary flow chart of the rendering portion of the media compensator 133 depicted in FIG. 5 in box 266. In this respect, to render the print preview 126, the media compensator begins with box 383 in which a first image of the digital document 119 is generated that does not simulate the digital document 119 as printed on the print media by the printer 106. Thereafter, in box 386, the first image is transformed by the media compensator 133 to generate the print preview 126 and applies the print preview image 126 to the display device 129 for presentation to the user. The particular transformation may involve several different calculations or other computing operations depending on the particular media material properties 169 of the respective print media and the printer attributes 173 of the printer 106 that affect the visual appearance of the digital document as it would be printed on the print media by the printer 106.

Although the print preview logic 123 and/or the media compensator 133 are embodied in software or code executed by general purpose hardware as discussed above, as an alternative each may also be embodied in dedicated hardware or a combination of software/general purpose hardware and dedicated hardware. If embodied in dedicated hardware, the print preview logic 123 and/or the media compensator 133 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The block diagrams and/or flow charts of FIGS. 1, 2, 5 and 6 show the architecture, functionality, and operation of an implementation of the print preview logic 123 and/or the media compensator 133. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 5 and 6 show a specific order of execution, it is understood that the order of execution may differ from that which is depicted. For example, the order of execution of two or more blocks may be scrambled relative to the order shown. Also, two or more blocks shown in succession in FIGS. 5 and 6 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the print preview logic 123 and/or the media compensator 133 comprises software or code, they can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the print preview logic 123 and/or the media compensator 133 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

What is claimed is:

1. A print preview method, comprising:
providing a digital document for printing;
specifying a print media upon which a digital document is to be printed, wherein a visual appearance of the digital document as printed on the print media is affected by a material property of the print media; and
rendering a print preview of the digital document on a display device, the print preview simulating the visual appearance of the digital document as affected by the material property of the print media.

2. The print preview method of claim 1, wherein the rendering of the print preview of the digital document on the display device, the print preview simulating the visual appearance of the digital document as affected by the material property of the print media further comprises:
generating a first image that simulates an initial visual appearance of the digital document that is not affected by the material property; and
transforming the first image into the preview image.

3. The print preview method of claim 1, further comprising:
specifying a printer upon which the digital document is to be printed, wherein the visual appearance of the digital document as printed by the printer is affected by a printer attribute of the printer; and
rendering the print preview of the digital document on the display device, the print preview simulating the visual appearance of the digital document as affected by the printer attribute of the printer.

4. The print preview method of claim 3, wherein the rendering of the print preview of the digital document on the display device, the print preview simulating the visual appearance of the digital document as affected by the printer attribute of the printer further comprises:
generating a first image of the digital document without the visual appearance of the digital document as affected by the printer attribute of the printer; and
processing the first image to generate the preview image that simulates the visual appearance for display on the display device.

5. The print preview method of claim 1, further comprising obtaining the at least one material property from a printer.

6. The print preview method of claim 1, further comprising obtaining the at least one material property from a remote server.

7. The print preview method of claim 6, wherein the obtaining of the at least one material property from the remote server further comprises transmitting a request for the at least one material property to the remote server, the request including a media type.

8. A print preview method, comprising:
providing a digital document for printing;
specifying a printer upon which the digital document is to be printed, wherein a visual appearance of the digital document as printed by the printer is affected by a printer attribute of the printer; and
rendering the print preview of the digital document on a display device, the print preview simulating the visual appearance of the digital document as affected by the printer attribute of the printer.

9. The print preview method of claim 8, wherein the rendering the print preview of the digital document on the display device, the print preview simulating the visual appearance of the digital document as affected by the printer attribute of the printer further comprises:
generating a first image of the digital document without the visual appearance of the digital document as affected by the printer attribute of the printer; and
processing the first image to generate the preview image that simulates the visual appearance for display on the display device.

10. A program embodied in a computer readable medium for generating a print preview, comprising:
code that provides for a specification of a print media upon which a digital document is to be printed, wherein a visual appearance of the digital document as printed on the print media is affected by a material property of the print media; and
code that generates a print preview of the digital document for display on a display device, the print preview simulating the visual appearance of the digital document as affected by the material property of the print media.

11. The program embodied in a computer readable medium of claim 10, wherein the code that generates the print preview of the digital document for display on the display device, the print preview simulating the visual appearance of the digital document as affected by the material property of the print media further comprises:
code that generates a first image that simulates an initial visual appearance of the digital document that is not affected by the material property; and
code that transforms the first image into the preview image.

12. The program embodied in a computer readable medium of claim 11, wherein the code that transforms the first image into the preview image further comprises code that modifies an amount of data of the first image according to a predefined routine to generate the preview image.

13. The program embodied in a computer readable medium of claim 10, further comprising:
code that provides for a specification of a printer upon which the digital document is to be printed, wherein the visual appearance of the digital document as printed by the printer is affected by a printer attribute of the printer; and
code that generates the print preview of the digital document for display on the display device, the print preview simulating the visual appearance of the digital document as affected by the printer attribute of the printer.

14. The program embodied in a computer readable medium of claim 13, wherein the code that generates the print preview of the digital document for display on the display device, the print preview simulating the visual appearance of the digital document as affected by the printer attribute of the printer further comprises:
code that generates a first image of the digital document without the visual appearance of the digital document as affected by the printer attribute of the printer; and
code that processes the first image to generate the preview image that simulates the visual appearance for display on the display device.

15. The program embodied in a computer readable medium of claim 10, further comprising code that obtains the at least one material property from a memory.

16. The program embodied in a computer readable medium of claim 10, further comprising code that obtains the at least one material property from a remote server.

17. The program embodied in a computer readable medium of claim 16, wherein the code that obtains the at least one material property from the remote server further comprises code that transmits a request for the at least one material property to the remote server, the request including a media type.

18. A program embodied in a computer readable medium for generating a print preview, comprising:
code that provides for a specification of a printer upon which a digital document is to be printed, wherein a visual appearance of the digital document as printed by the printer is affected by a printer attribute of the printer; and
code that generates the print preview of the digital document for display on a display device, the print preview simulating the visual appearance of the digital document as affected by the printer attribute of the printer.

19. The program embodied in a computer readable medium of claim 18, wherein the code that generates the print preview of the digital document for display on the display device, the print preview simulating the visual appearance of the digital document as affected by the printer attribute of the printer further comprises:
code that generates a first image of the digital document without the visual appearance of the digital document affected by the printer attribute of the printer; and
code that processes the first image to generate the preview image that simulates the visual appearance for display on the display device.

20. A print preview system, comprising:
a processor circuit having a processor and a memory;
a display device in data communication with the processor circuit;
a media compensator stored in the memory and executable by the processor, the media compensator comprising:
logic that provides for a specification of a print media upon which a digital document is to be printed, wherein a visual appearance of the digital document as printed on the print media is affected by a material property of the print media; and
logic that generates a print preview of the digital document for display on the display device, the print preview simulating the visual appearance of the digital document as affected by the material property of the print media.

21. The print preview system of claim 20, wherein the logic that generates the print preview of the digital document for display on the display device, the print preview simulating the visual appearance of the digital document as affected by the material property of the print media further comprises:
logic that generates a first image that simulates an initial visual appearance of the digital document that is not affected by the material property; and
logic that transforms the first image into the preview image.

22. The print preview system of claim 20, further comprising:
logic that provides for a specification of a printer upon which the digital document is to be printed, wherein the visual appearance of the digital document as printed by the printer is affected by a printer attribute of the printer; and
logic that generates the print preview of the digital document for display on the display device, the print preview simulating the visual appearance of the digital document as affected by the printer attribute of the printer.

23. The print preview system of claim 22, wherein the logic that generates the print preview of the digital document for display on the display device, the print preview simulating the visual appearance of the digital document as affected by the printer attribute of the printer further comprises:
logic that generates a first image of the digital document without the visual appearance of the digital document as affected by the printer attribute of the printer; and
logic that processes the first image to generate the preview image that simulates the visual appearance for display on the display device.

24. The print preview system of claim 20, further comprising logic that obtains the at least one material property from a memory.

25. The print preview system of claim 20, further comprising logic that obtains the at least one material property from a remote server.

26. A print preview system, comprising:
a processor circuit having a processor and a memory;
a display device in data communication with the processor circuit;
a media compensator stored in the memory and executable by the processor, the media compensator comprising:
logic that provides for a specification of a printer upon which a digital document is to be printed, wherein a visual appearance of the digital document as printed by the printer is affected by a printer attribute of the printer; and
logic that generates the print preview of the digital document for display on the display device, the print preview simulating the visual appearance of the digital document as affected by the printer attribute of the printer.

27. The print preview system of claim 26, wherein the logic that generates the print preview of the digital document for display on the display device, the print preview simulating the visual appearance of the digital document as affected by the printer attribute of the printer further comprises:
logic that generates a first image of the digital document without the visual appearance of the digital document affected by the printer attribute of the printer; and
logic that processes the first image to generate the preview image that simulates the visual appearance for display on the display device.

28. A print preview system, comprising:
means for providing for a specification of a print media upon which a digital document is to be printed, wherein a visual appearance of the digital document as printed on the print media is affected by a material property of the print media; and
means for generating a print preview of the digital document for display on the display device, the print preview simulating the visual appearance of the digital document as affected by the material property of the print media.

29. The print preview system of claim 28, wherein the means for generating the print preview of the digital document for display on the display device, the print preview simulating the visual appearance of the digital document as affected by the material property of the print media further comprises:
means for generating a first image that simulates an initial visual appearance of the digital document that is not affected by the material property; and
means for transforming the first image into the preview image.

30. A print preview system, comprising:
means for specifying a printer upon which a digital document is to be printed, wherein a visual appearance of the digital document as printed by the printer is affected by a printer attribute of the printer; and
means for rendering the print preview of the digital document on a display device, the print preview simulating the visual appearance of the digital document as affected by the printer attribute of the printer.
